(19) United States
(12) Patent Application Publication
(10) Pub. No.: US 2003/0057025 A1
(43) Pub. Date: Mar. 27, 2003

(54) Shoe size selection process and associated device and assembly

(75) Inventor: Bruce Cagner, Dix Hills, NY (US)

Correspondence Address: COLEMAN SUDOL SAPONE, P.C., 714 Colorado Avenue, Bridgeport, CT, 06605-1601, US

(73) Assignee: BCNY INTERNATIONAL, INC.

(21) Appl. No.: 09/962,966

(22) Filed: Sep. 24, 2001

(51) Int. Cl. B61B 1/00; B65G 1/00; E04H 3/00; B07C 5/00

(52) U.S. Cl. 186/52; 209/547

(57) ABSTRACT

In a method of garment selection, a customer enters a retail outlet having a sales display including (a) a plurality of articles of clothing of a given type in different standard sizes and (b) a plurality of first sizing markers each corresponding to a respective one of the standard sizes and disposed in physical proximity to respective ones of the articles of clothing. The articles of clothing and the first sizing markers are disposed in an arrangement facilitating perception of the first sizing markers and selection of appropriate sizes of the articles of clothing by prospective customers. The customer approximates a body part to at least one sizing shape of a plurality of geometrically similar shapes corresponding to the given type of the articles of clothing, where the shapes have different sizes corresponding to respective ones of the standard sizes of the articles of clothing and are juxtaposed to respective second sizing markers differing perceptibly from one another from one another so as to identify different standard sizes of the articles of clothing. Each of the first sizing markers associated with a given common standard size of the articles of clothing shares a visually perceptible characteristic with a respective one of the second sizing markers associated with the respective ones of the given standard sizes. One of the articles of clothing is selected which has a respective first sizing marker with the same characteristic or parameter as the sizing second marker juxtaposed to the one sizing shape.

### BACKGROUND OF THE INVENTION

This invention relates to a method useful in the retail industry for facilitating the selection of clothing. More specifically, the method of this invention facilitates the selection of the sizes of clothing articles such as footwear.

The selection of clothing for children and by children is encumbered by the children's growth. Their clothing sizes constantly change, albeit at different rates depending on the age of the child. Small children cannot make selections themselves, for various reasons, including their inability to determine their size and to select clothing of the appropriate size.

### OBJECTS OF THE INVENTION

It is an object of the present invention to provide a method or system for facilitating the selection of clothing of appropriate sizes.

It is a more particular object to provide a method or system for facilitating the selection of clothing of appropriate sizes for children and/or by children.

An even more particular object of the present invention is to provide a method or system for facilitating the selection of children's shoes.

Yet another object of the present invention is to provide a device disposable at retail clothing displays, for instance, shoe displays, for facilitating size selection.

These and other objects of the invention will be apparent from the drawings and descriptions herein. It is to be noted that every embodiment of the invention is believed to attain at least one object set forth herein. However, it is not deemed necessary for every embodiment of the invention to attain all of the objects set forth herein.

### SUMMARY OF THE INVENTION

The present invention is directed in part to a method of selecting sizes of articles of clothing. The method is particularly designed for use in the retail industry and more particularly facilitates the determination of garment size and the selection of appropriately sized articles of clothing. The method is especially helpful for assisting children and adults in the selection of children's clothing such as shoes.

A method for facilitating garment selection comprises, in accordance with the present invention, providing a plurality of articles of clothing of a given type in different standard sizes and additionally providing a plurality of first sizing markers each corresponding to a respective one of the standard sizes. The articles of clothing and the first sizing markers are disposed in an arrangement facilitating perception of the first sizing markers and selection of appropriate sizes of the articles of clothing by prospective customers. The first sizing markers are disposed in physical proximity to respective articles of clothing. The method further entails providing a plurality of geometrically similar shapes corresponding to the given type of the articles of clothing, the shapes having different sizes corresponding to respective ones of the standard sizes of the articles of clothing. In addition, a plurality of second sizing markers equal in number to the shapes are provided, the second sizing markers differing perceptibly from one another from one another so as to identify different standard sizes of the articles of clothing. Each of the first sizing markers associated with a given common standard size of the articles of clothing shares a visually perceptible characteristic or parameter with a respective one of the second sizing markers. The shapes and the second sizing markers are disposed in paired relationship in proximity to the arrangement of the articles of clothing and the first sizing markers, thereby facilitating a customers' selection of the articles of clothing of appropriately sizes.

Where the articles of clothing are shoes, the sizing shapes are preferably taken from the group consisting of foot prints and shoe prints. Thus, customers such children merely place their feet on the sizing shapes, for instance, within the outlines of the shoe prints or foot prints, to determine their shoe size. The second sizing markers may take the form of areas of color. The areas of color may be bounded by the outlines of the shoe prints or foot prints. Alternatively or additionally, a separate area of color may be provided in close juxtaposition to the foot prints or shoe prints. Typically, the colors of different sizes are colors of the rainbow, easily identified by children.

The first sizing markers are similarly swatches or patches of color disposed in close physical proximity to the shoes. The color may be provided on tags attached to the shoes. Alternatively, the shoe boxes or shoe supports on which the shoes are disposed may be provided with color areas coding the shoe size. Each entire shoe boxes or shoe support may be of the appropriate sizing color. Or a portion of the box or shoe support may be provided with an area of the appropriate color in a predetermined, visually accessible location.

Clearly, the method of the present invention greatly facilitates the selection of shoes either by children or by adults. Color is an easily recognized characteristic, even to children who are not yet capable of recognizing numbers. Where the color is applied to a large area, such as to an entire shoe box or molded display support, shoe size recognition by children proceeds apace, with a minimum of error as to shoe size.

The use of color as a size encoding characteristic is also entertaining to children. Color is a basic perceptual quality of the physical world and is closely associated with emotion. Children more readily talk about favorite colors than favorite shoe sizes.

The sizing markers of the present invention may take forms other than color. For instance, graphical cartoon characters may be use to designate size. The cartoon characters may be pre-existing, from the popular culture. Generally, licensing is necessary in this case. Alternatively, new characters may be devised. The characters may be anthropomorphic representations of animals, plants, etc. Or the characters may be photographic representations of animals or other objects of interest to children.

It is contemplated that the sizing shapes are all disposed on a single substrate such as a mat or a pad which is disposed on a floor surface in proximity to the display or collection of items of clothing. The use of a single display is convenient from a manufacturing and display perspective. In fact, a plurality of identical unitary substrates may be provided near a clothing rack or shoe display, each provided with sizing shapes corresponding to all standard sizes within a predetermined range (e.g., all children's sizes for a range of ages). Alternatively, a plurality of different substrates may be provided, each substrate carrying only a subset of the entire range of clothing sizes.

Other clothing articles other than shoes may be selected according to the sizing technique disclosed herein. Possibilities includes gloves and mittens or pairs of pants. In the latter case, the sizing shapes may be the lower portions of trousers, from the knee down. The customer may juxtapose his or her lower leg to the sizing shapes provided, for instance, along a vertical substrate surface such as a wall or post.

A device for facilitating garment selection comprises, in accordance with the present invention, a substrate disposable in proximity to a sales display of articles of a given type of clothing having a plurality of different standard sizes. The substrate is provided with a plurality of geometrically similar sizing shapes of different sizes corresponding to the different standard sizes of the given type of clothing. The substrate is further provided with a plurality of marker elements juxtaposed to respective ones of the sizing shapes, each given one of the marker elements having a visually perceptible characteristic or parameter which is unique to the given one of the marker elements.

The substrate may take any form capable of carrying sizing shapes and suitable for placement in proximity to a clothing display or rack in a retail outlet. A substrate may be a planar object such as a mat or web, or even a film disposable on and connectable to a surface such as a floor, a wall, an inclined surface of a wedge or piece of furniture. The substrate may be a floor or wall surface, an article of furniture, or a panel thereof. The substrate may be an independent structure such as a pedestal, post, or platform.

The articles of clothing may be shoes. In that case, the sizing shapes may foot prints and shoe prints.

The visually perceptible characteristic or parameter may be color. In that case, different colors may be disposed within the boundaries or outlines of the foot prints or shoe prints or in other geometrical areas separate from the shoe prints or foot prints.

A related method of garment selection comprises, pursuant to the present invention, entering a retail outlet having a sales display including (a) a plurality of articles of clothing of a given type in different standard sizes and (b) a plurality of first sizing markers each corresponding to a respective one of the standard sizes and disposed in physical proximity to respective ones of the articles of clothing, the articles of clothing and the first sizing markers being disposed in an arrangement facilitating perception of the first sizing markers and selection of appropriate sizes of the articles of clothing by prospective customers. A body part is then approximated to at least one sizing shape of a plurality of geometrically similar shapes corresponding to the given type of the articles of clothing, where the shapes have different sizes corresponding to respective ones of the standard sizes of the articles of clothing and are juxtaposed to respective second sizing markers differing perceptibly from one another from one another so as to identify different standard sizes of the articles of clothing. Each of the first sizing markers associated with a given common standard size of the articles of clothing shares a visually perceptible characteristic or parameter with a respective one of the second sizing markers associated with the respective ones of the given standard sizes. One of the articles of clothing is selected which has a respective first sizing marker with the same characteristic or parameter as the sizing second marker juxtaposed to the one sizing shape. The selected one article of clothing is removed from the sales display and purchased.

A sales display assembly comprises, in accordance with the present invention, a plurality of articles of clothing of a given type, a support structure carrying the articles of clothing in an array, and a plurality of first marker elements disposed in physical proximity to the articles of clothing, the marker elements having a characteristic or parameter with a plurality of different forms corresponding to respective different standard sizes of the articles of clothing. The sales display assembly additionally comprises a substrate disposed in proximity to the support structure and the articles of clothing, the substrate being provided with (a) a plurality of sizing shapes of the different standard sizes disposed in a predetermined array and (b) a plurality of second marker elements equal in number to the sizing shapes, each given one of the second marker elements having at least one characteristic or parameter which is unique to the given one of the second marker elements and which is identical to the characteristic or parameter of at least one of the first marker elements.

Where the articles of clothing are shoes, the sizing shapes may be foot prints or shoe prints. Where the characteristic or parameter is a color, the second marker elements may be areas of color surrounded by outlines of the sizing shapes. The substrate may be one or more unitary structures such as mats or pads.

A method and display assembly pursuant to the present invention is particularly useful in the marketing of shoes and other articles of clothing for children. The identification or codification of garment sizes by color or cartoon character engages children's attention and enables them to take an active part in the selection of appropriately sized shoes and other garments.

### BRIEF DESCRIPTION OF THE DRAWINGS

FIG. 1 is a schematic plan view of a device for assisting in the selection of shoes by retail customers.

FIG. 2 is a schematic perspective view of a retail display utilizing the device of FIG. 1.

### DEFINITIONS

The word “clothing” or “garment” is used herein to denote any type of manufactured article which a person may wear and which comes in different sizes to match differently sized human beings. Clothing and garments thus include shoes, socks, gloves, pants, shirts, etc.

The word “substrate” is used herein to designate any physical structure capable of carrying shapes of a clothing or garment or human body part. Thus, a substrate may be a planar object such as a mat or web, or even a film disposable on and connectable to a surface such as a floor, a wall, an inclined surface of a wedge or piece of furniture. The substrate may be a floor or wall surface, an article of furniture, or a panel thereof. The substrate may be an independent structure such as a pedestal, post, platform. The substrate may be a single unitary structure or a plurality of structures (e.g., several mats or films) each carrying only a subset of the sizing shapes needed to span the sizes in a predetermined range.

The term “sizing shape” as used herein with reference to a type of clothing article or a body part means an outline, silhouette, contour, relief structure, or an arrangement of elements such as knobs, or markings which define a form of the clothing article or associated body part. In the case of shoes, a shape may take the form of a two-dimensional foot or shoe print, or a well or recess approximating the bottom of a foot or shoe. The same applies to gloves or mittens. Similarly, in the case of pants, a sizing shape may correspond to the lower leg from the knee down. In any case, a sizing shape as discussed herein is provided a substrate preferably disposed in proximity to a sales display. Several geometrically similar sizing shapes are disposed on the same substrate or on different substrates all disposed in proximity to the sales display for facilitating the selection of an appropriate size of clothing article or garment by customers. The different geometrically sizing shapes are in a plurality of different standard sizes matching the standard sizes of the respective type of clothing or garment.

The term “marker,” “sizing marker,” or “marker element” is a visually perceptible element which may be placed in physical proximity to a sizing shape for coding the standard size of the respective sizing shape. A sizing marker has a characteristic or parameter which perceptibly differs from the characteristics of other sizing markers. Different sizing markers are physically associated with the differently dimensioned sizing shapes and with clothing articles to facilitate customer determination of the sizes of the different clothing articles and to find a match to the customers' sizes. The sizing markers are preferably colors or symbols which are readily recognized by children. In the case of colors, the colors may fill the outlines of the sizing shapes and/or associated forms placed adjacent to the sizing shapes. Sizing markers may also take the form of graphic characters, for example, well-known cartoon characters licensed from the respective media companies, or new characters created specially for the clothing size selection process disclosed herein. The graphic character representations may be disposed within the sizing shapes, adjacent thereto, or around the sizing shapes.

### DETAILED DESCRIPTION OF THE PREFERRED EMBODIMENTS

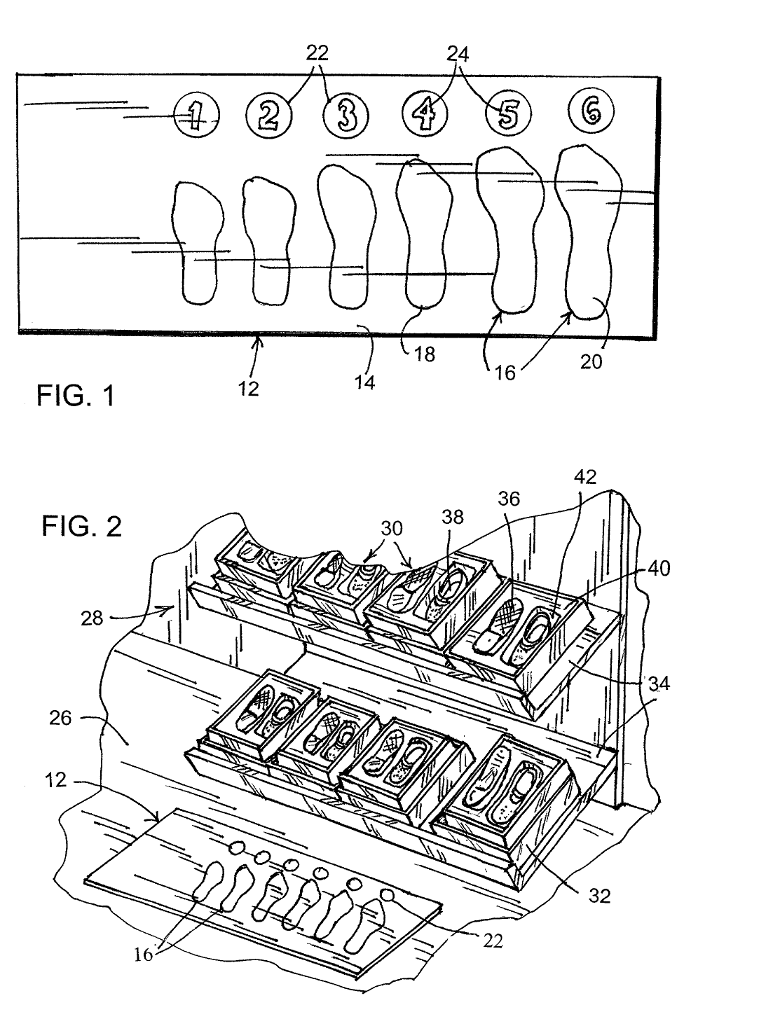

FIG. 1 illustrates a device 12 for assisting retail customers in the selection of shoes and more particularly in the selection of shoes of appropriate size. Shoe selection assistance device 12 may be used by retail customers with or without the assistance of store personnel.

Shoe size selection assistance device 12 includes a substrate in the form of a mat or pad provided on an upper surface 14 with a plurality of geometrically similar sizing shapes 16 of different sizes. Sizing shapes 16 correspond to different standard shoe sizes generally within a given wearer age range. More specifically, sizing shapes 16 are foot or shoe prints defined by outlines or boundary lines 18 surrounding color areas 20. The color of each area 20 differs perceptibly from the colors of other areas 20 and uniquely serves as a marker or identifier of shoe size.

Shoe size selection mat or pad 12 is optionally provided with additional size markers 22 equal in number to sizing shapes or prints 16 and taking the form, for example, of circular patches of color each matching the color within the adjacent sizing shape or print 16. Numbers 24 or alphabet letters may be additionally provided inside circular size markers 22 as shown or inside sizing shapes or prints 16, the numbers may be standard numerical designations of shoe size or may be the result of an arbitrary labeling scheme.

As illustrated in FIG. 2, mat or pad 12 is disposable on a floor surface 26 in proximity to a retail sales display 28 of pairs of shoes 30 having a plurality of different standard sizes. Shoes 30 are typically displayed in respective shipping boxes 32 placed in an open configuration on shelves 34, whereby prospective customers are able to visually inspect the shoes. More specifically, shoes 36 and 38 of each pair are disposed on a molded support 40 having one or two cavities or wells 42 for holding one shoe 36 in an upside down orientation (for viewing of the sole) and the other shoe 38 in a right side up or sideways orientation. Supports 40 may be provided in the different sizing colors in sizing print areas 20 and size markers 22 on shoe size selection mat or pad 12. The colors of supports 40 are selected to mark or identify the sizes of the respective pairs of shoes 30.

Accordingly, to select a pair of shoes 30 of an appropriate size, a customer first places his or her foot (e.g., right foot) on the sizing prints 16 to find a matching size. For instance, the customer may select a size so that the customer's foot just fits within the outline 18 of one of the sizing shapes or prints 16. The customer notes the size-encoding color of the matching print 16 and then scans display 28 for a shoe box 32 which has a support 40 of the appropriate color and which also holds shoes 30 of a desirable look, feel and/or label. The selected shoes 30 are removed from the shelf 34 and eventually purchased.

It is to be noted that size marking or coding may be accomplished by symbols other than color, although color is preferable particularly for certain youthful age groups. Other size marking symbols include graphic cartoon characters and photographic representations of animals and other objects of interest to children. Another size marking or coding technique might use corporate logos associated, for instance, with children's products in the toy, food, or entertainment industries.

It is to be additionally noted that the sizing markers may be disposed at a location other than on supports 40. For instance, stickers (not shown) of the appropriate colors may be attached to the boxes 32 or to the shoes themselves. Alternatively, each shoe 36, 39 may be provided with one or more parts (sole, upper panel, shoe lace, etc.) having the color encoding the size of the shoe. A “racing stripe” in the size color may be provided on the shoes 36, 38.

It is to be noted further that sizing shapes or prints 16 may be provided on more than one mat or pad 12. Each such mat or pad might include only some of the sizes available in shoe display 28. Moreover, different shoe size selection pads 12 may be provided with different kinds of sizing markers. One pad 12 may have color coding, while another pad has cartoon characters or animal pictures.

Shoes 30 are articles of clothing provided in different standard sizes in a retail outlet and are physically associated with size coding markers such as the colors of supports 40 or labels, tags, etc. These sizing markers each correspond to a respective one of the standard shoe sizes. The shoes 30 and the respective sizing markers are disposed in an arrangement on display 28 facilitating perception of the sizing markers and the selection of appropriate sizes of shoes 30 by prospective customers. The physical association of the sizing markers with the shoes 30 generally entails a physical connection. For instance, the shoes 30 are disposed on supports 40. Alternatively, tags or labels (not shown) carrying the appropriate sizing markers (color, graphics) are fastened to the shoes 30, the supports 40, or the boxes 32. In any event, the physical association results in a proximity of the sizing markers to the shoes effective to enable ready size recognition by customers. As discussed above, geometrically similar sizing shapes or prints 16 provided in proximity to display 28 correspond to the shapes of the shoes or feet and have different sizes corresponding to respective standard shoes sizes. The sizing shapes or prints 16 are associated with, i.e., disposed effectively proximate to, sizing markers 20 and/or 22 for encoding and identifying the shoe sizes to which the sizing shapes or prints 16 correspond. These additional sizing markers 20, 22 have a characteristic (color) which differs perceptibly across the different markers or sizing shapes 16 so as to identify different standard shoe sizes within a predetermined range. Thus, each of the sizing markers (40) associated with the shoes 30 shares a visually perceptible characteristic or parameter (color) with one sizing marker associated with a respective sizing shape 16.

Although the invention has been described in terms of particular embodiments and applications, one of ordinary skill in the art, in light of this teaching, can generate additional embodiments and modifications without departing from the spirit of or exceeding the scope of the claimed invention. For instance, the method discussed hereinabove may be used to facilitate the selection of garments other than shoes, such as gloves, pants or shirts. In the latter cases, the sizing shapes may correspond to lower legs and sleeves.

The substrate or substrates on which the sizing shapes are provided may be an article of furniture or other three-dimensional structure. In the case of shoes, the sizing prints might be provided along an inclined surface of a wedge, with the customer measuring his or her foot in a seated posture. Where the garments are gloves or mittens, the sizing shapes (without or without fingers) may be provided on a wall or on a mat or film attached to a wall.

Accordingly, it is to be understood that the drawings and descriptions herein are proffered by way of example to facilitate comprehension of the invention and should not be construed to limit the scope thereof.

What is claimed is:

1. A method for facilitating garment selection, comprising:
providing a plurality of articles of clothing of a given type in different standard sizes;
additionally providing a plurality of first sizing markers each corresponding to a respective one of said standard sizes;
disposing said articles of clothing and the first sizing markers in an arrangement facilitating perception of said first sizing markers and selection of appropriate sizes of said articles of clothing by prospective customers, said first sizing markers being disposed in physical proximity to respective ones of said articles of clothing;
further providing a plurality of geometrically similar shapes corresponding to said given type of said articles of clothing, said shapes having different sizes corresponding to respective ones of said standard sizes of said articles of clothing;
also providing a plurality of second sizing markers equal in number to said shapes, said second sizing markers differing perceptibly from one another from one another so as to identify different standard sizes of said articles of clothing, each of said first sizing markers associated with a given common standard size of said articles of clothing sharing a visually perceptible characteristic or parameter with a respective one of said second sizing markers associated with said respective ones of said given standard sizes; and
disposing said shapes and said second sizing markers in paired relationship in proximity to said arrangement of said articles of clothing and said first sizing markers, thereby facilitating a customers' selection of said articles of clothing of appropriately sizes.

2. The method defined in claim 1 wherein said articles of clothing are shoes.

3. The method defined in claim 2 wherein said sizing shapes are taken from the group consisting of foot prints and shoe prints.

4. The method defined in claim 3 wherein said visually perceptible characteristic or parameter is color.

5. The method defined in claim 4 wherein said first sizing markers are shoe supports provided with respective sizing colors.

6. The method defined in claim 4 wherein said second sizing markers are areas of color surrounded by outlines of said sizing shapes.

7. The method defined in claim 3 wherein said sizing shapes are all disposed on a single substrate.

8. The method defined in claim 7 wherein said substrate is a mat or pad.

9. The method defined in claim 1 wherein said sizing shapes are all disposed on a single substrate.

10. A device for facilitating garment selection, comprising a substrate disposable in proximity to a sales display of articles of a given type of clothing having a plurality of different standard sizes, said substrate being provided with a plurality of geometrically similar sizing shapes of different sizes corresponding to said different standard sizes of said given type of clothing, said substrate being further provided with a plurality of marker elements juxtaposed to respective ones of said sizing shapes, each given one of said marker elements having a visually perceptible characteristic or parameter which is unique to said given one of said marker elements.

11. The device defined in claim 10 wherein said articles of clothing are shoes.

12. The device defined in claim 11 wherein said sizing shapes are taken from the group consisting of foot prints and shoe prints.

13. The device defined in claim 12 wherein said visually perceptible characteristic or parameter is color.

14. The device defined in claim 13 wherein said marker elements are areas of color surrounded by outlines of said sizing shapes.

15. The device defined in claim 12 wherein said substrate is a single unitary structure.

16. The device defined in claim 15 wherein said substrate is a mat or pad.

17. The device defined in claim 10 wherein said substrate is a single unitary structure.

18. A method of garment selection, comprising:
entering a retail outlet having a sales display including a plurality of articles of clothing of a given type in different standard sizes, a plurality of first sizing markers each corresponding to a respective one of said standard sizes, said articles of clothing and the first sizing markers being disposed in an arrangement facilitating perception of said first sizing markers and selection of appropriate sizes of said articles of clothing by prospective customers, said first sizing markers being disposed in physical proximity to respective ones of said articles of clothing;
approximating a body part to at least one sizing shape of a plurality of geometrically similar shapes corresponding to said given type of said articles of clothing, said shapes having different sizes corresponding to respective ones of said standard sizes of said articles of clothing, said shapes being juxtaposed to respective second sizing markers differing perceptibly from one another from one another so as to identify different standard sizes of said articles of clothing, each of said first sizing markers associated with a given common standard size of said articles of clothing sharing a visually perceptible characteristic or parameter with a respective one of said second sizing markers associated with said respective ones of said given standard sizes; and
selecting one of said articles of clothing having a respective first sizing marker with the same characteristic or parameter as the sizing second marker juxtaposed to said one sizing shape;
removing the selected one of said articles of clothing from said sales display; and
purchasing the selected one of said articles of clothing.

19. A sales display assembly comprising:
a plurality of articles of clothing of a given type;
a support structure carrying said articles of clothing in an array;
a plurality of first marker elements disposed in physical proximity to said articles of clothing, said marker elements having a characteristic or parameter with a plurality of different forms corresponding to respective different standard sizes of said articles of clothing; and
a substrate disposed in proximity to said support structure and said articles of clothing, said substrate being provided with a plurality of sizing shapes of said different standard sizes disposed in a predetermined array, said substrate also being provided with a plurality of second marker elements equal in number to said sizing shapes, each given one of said second marker elements having at least one characteristic or parameter which is unique to said given one of said second marker elements and which is identical to the characteristic or parameter of at least one of said first marker elements.

20. The assembly defined in claim 19 wherein said articles of clothing are shoes.

21. The assembly defined in claim 20 wherein said sizing shapes are taken from the group consisting of foot prints and shoe prints.

22. The assembly defined in claim 21 wherein said characteristic or parameter is a color.

23. The assembly defined in claim 22 wherein said second marker elements are areas of color surrounded by outlines of said sizing shapes.

24. The assembly defined in claim 21 wherein said substrate is a single unitary structure.

25. The assembly defined in claim 24 wherein said substrate is a mat or pad.

26. The assembly defined in claim 19 wherein said substrate is a single unitary structure.
